(19) United States
(12) Patent Application Publication
(10) Pub. No.: US 2016/0184747 A1
(43) Pub. Date: Jun. 30, 2016

(54) FILTERS, SUPPORTS FOR FILTERS, AND METHODS OF PRODUCING FILTERS HAVING SUPPORTS

(71) Applicants: Jordan SALPIETRA, Shreveport, LA (US); Glenn David ALEXANDER, Dunedin (NZ)

(72) Inventors: Jordan SALPIETRA, Shreveport, LA (US); Glenn David ALEXANDER, Dunedin (NZ)

(21) Appl. No.: 14/910,517

(22) PCT Filed: Aug. 7, 2014
(86) PCT No.: PCT/US14/50172

§ 371 Date: Feb. 5, 2016

Related U.S. Application Data
(60) Provisional application No. 61/863,367, filed on Aug. 7, 2013.

(51) Int. Cl. B01D 29/96; B01D 39/16; B01D 29/05; B01D 29/01

(52) U.S. Cl. CPC B01D 29/96; B01D 29/012; B01D 39/1623; B01D 39/1615; B01D 29/05

(57) ABSTRACT

A filter assembly includes a filter media comprising at least one of wool, viscose, and thermoplastic polymer material; a supporting layer proximate to the filter media comprising at least one of a mesh, a frame, and a thin board; and a retaining member configured to engage the filter media and the supporting layer to hold the filter media and supporting layer together. A method of manufacturing a filter assembly includes carding fibers into a web to form a filter media comprising at least one of wool, viscose, and thermoplastic polymer material; coupling the filter media with a supporting layer comprising at least one of a mesh, a frame, and a thin board, and trimming or punching the coupled filter media and supporting layer to a predetermined size.

### BACKGROUND OF THE INVENTION

### Field of the Invention

The invention relates generally to filters, supports for filters, and methods of producing filters having supports.

### SUMMARY OF THE INVENTION

Filters may be designed for use in commercial kitchens to capture grease before it enters the extraction and ventilation systems. Various materials (e.g., natural fibers, synthetic fibers, and hybrid fibers) may be used for the filter media, including, for example, Kapok as a natural fiber to be added to the filter media.

An internal frame manufactured from a resin impregnated paper may be used as the support for the filter and this may be mounted on Z brackets about ¾ to 1 inch in front of UL 1046 baffles. This frame may biodegrade over a period of time. This internal frame structure may typically be ⅛ to ½ inch thick and must have sufficient strength to be able to withstand the pressure created by the fan in the ventilation system as well as the tests for UL 1046 and UL 710. When a frame is not required to be biodegradable, a wire or metal frame may also be used (e.g., 9 gauge wire). Alternatively, the frame may be adjacent to the filter as a non-internal frame.

This system of using the internal frame requires a retro-fit to existing hoods if the UL 1046 baffle is, for example, 2 inches deep. The retro-fit requires the addition of a Z bracket, either welded or fitted in place. Another method is to replace the 2-inch wide baffles with 1-inch baffles and fit the filters in the existing rail. Nevertheless, the Z brackets and fitting with 1-inch baffles may create additional costs and inconvenience.

According to an embodiment of the invention, a filter assembly may comprise a mesh internal support.

According to another embodiment of the invention, a filter assembly may comprise a thin internal support.

According to a further embodiment of the invention, a filter may comprise blended materials (e.g., wool and viscose) as well as multiple layers of various materials combined in a multi-laminated structure.

A multi-layered filter assembly may include a filter media comprising at least one of wool, viscose, and thermoplastic polymer material; a supporting layer proximate to the filter media comprising at least one of a mesh, a frame, and a thin board; and a retaining member configured to engage the filter media and the supporting layer to hold the filter media and supporting layer together. The supporting layer may be next to the filter media or there may be intervening layers or materials. The supporting layer may be sandwiched between two or more layers of the filter media. The filter media may include multiple layers of blended fibers and one or more of the layers may be treated with a fire resistant additive. The mesh for the supporting layer may comprise at least one of fiberglass, viscose, cotton, mineral fiber, and metal. The mesh may be fire resistant or treated with a fire resistant additive. The retaining member may be configured to engage with an opening in the filter media or may contact a perimeter portion of the filter media. The filter media has a length and a width and the retaining member may be configured to extend along the width direction of the filter media. The retaining member may be configured to engage with a handle at each of opposite ends of the filter assembly, such that a retaining force is applied to the filter media, and the retaining member extends along the length direction. An opening may be formed in the filter media in each of opposite ends in the length direction of the filter media, with each opening configured to accommodate a portion of each handle, respectively. Alternatively, the handle may be connected to or integral with the retaining member. The thin board as the supporting layer may comprise at least one of fiberboard, metal, and resin. The retaining member may include a central portion and a clip portion at each of opposite ends of the central portion. The clip portion may include a portion that extends from the central portion to form an angle with the central portion.

A method of manufacturing a multi-layered filter assembly may include carding fibers into a web to form a filter media comprising at least one of wool, viscose, and thermoplastic polymer material; coupling the filter media with a supporting layer comprising at least one of a mesh, a frame, and a thin board; and trimming or punching the coupled filter media and supporting layer to a predetermined size. The coupling may include at least one of gluing, sewing, or needling in a needle loom.

### BRIEF DESCRIPTION OF THE DRAWINGS

For a more complete understanding of the embodiments of the present invention, needs satisfied thereby, and the objects, features, and advantages thereof, reference now is made to the following description taken in connection with the accompanying drawings.

FIG. 1 is a top view of a filter assembly, according to an embodiment of the invention.

FIG. 2 is a perspective view of a filter assembly, according to an embodiment of the invention.

FIG. 3 is a side view of a filter assembly, according to an embodiment of the invention.

FIG. 4 is a front side view of a filter assembly, according to an embodiment of the invention.

FIG. 5 is a top view of a filter assembly, according to a further embodiment of the invention.

FIG. 6 is a perspective view of a filter assembly, according to a further embodiment of the invention.

FIG. 7 is a side view of a filter assembly, according to a further embodiment of the invention.

FIG. 8 is a front side view of a filter assembly, according to a further embodiment of the invention.

FIG. 9 is a top view of a filter, according to an embodiment of the invention.

FIG. 10 is an exploded view of a filter, according to an embodiment of the invention.

FIG. 11A is a side view of a filter retainer, according to an embodiment of the invention.

FIG. 11B is a perspective view of a filter retainer, according to an embodiment of the invention.

FIG. 12A is a side view of a filter retainer, according to another embodiment of the invention.

FIG. 12B is a perspective view of a filter retainer, according to another embodiment of the invention.

FIG. 13 is a perspective partial view of a filter assembly with a filter retainer, according to a further embodiment of the invention.

FIG. 14 is a perspective partial view of a filter assembly with a filter retainer, according to a further embodiment of the invention.

FIG. 15 is a perspective view of a filter assembly with a filter retainer, according to a further embodiment of the invention.

FIG. 16 is a perspective view of a filter with a filter frame, according to an embodiment of the invention.

FIG. 17 is a side view of a filter retainer, according to a further embodiment of the invention.

### DETAILED DESCRIPTION OF EMBODIMENTS OF THE INVENTION

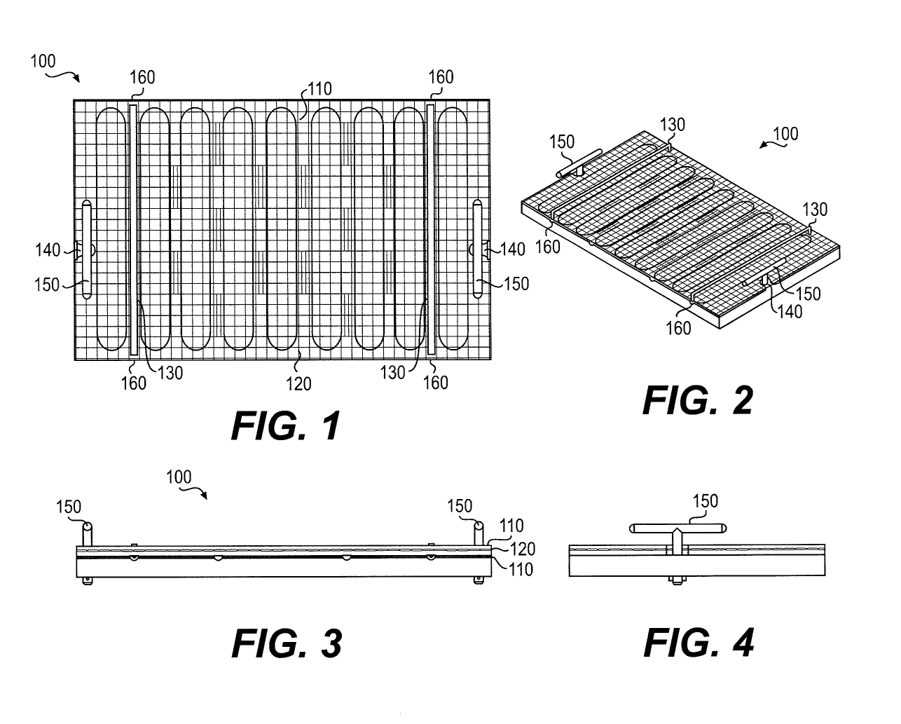

Embodiments of the present invention, and their features and advantages, may be understood by referring to FIGS. 1-17, like numerals being used for corresponding parts in the various drawings.

According to an embodiment of the invention, a filter assembly may comprise a mesh internal support. The mesh may be lower cost and may be introduced in the production process, allowing a fully integrated production process to manufacture the filters. For example, the mesh may be layered on top of the filter media in line. The mesh may be used with one fibrous mat or may be placed in between two fibrous mats. The assembly may be glued or sewn together or may be needled in a needle loom. All of these processes may be achieved in line.

The resulting product may then be trimmed to size or punched to size in a sample press and packed straight off the line. This may allow the filter production to be continuous and may significantly reduce costs. The mesh itself may be manufactured from natural or synthetic materials, including those with fire resistant properties, for example. Alternatively, fire resistant treatment of the mesh may be included in the production process. A fiberglass mesh may provide excellent properties at a low cost, along with any other mesh from a mineral fiber. Also, viscose mesh or cotton mesh may alternatively be used. Similarly, an aluminum mesh or grid or any metal capable of being made into a grid or mesh may be used.

An advantage of a mesh is that it may be used to form shapes which would allow greater surface areas to capture the grease particles, such as a pleated structure.

In addition to processing other chemicals such as binders, fire resistant additives may be applied by running the mesh in a chemical bath or may be applied with a spray application. This processing may enhance the desired properties of the mesh. The mesh may replace the internal stabilizer frame as support for the filter media.

The filter may be installed by attaching the filter directly onto the front face of the UL 1046 flame barrier, particularly for a high efficiency baffle filter. The mesh may provide sufficient support, so the filter does not bend or move away from the face of the filter when an exhaust fan is operating. As additional support, one or more metal or wire supports may be used to hold the filter media in place.

According to another embodiment of the invention, a filter assembly may comprise a thin internal support. For example, the internal frame may be made using a thin material, such as fiber hoard, metal, resin, or the like, with a thickness of for example, 1/64 inch, 3/64 inch, 1/16 inch, or the like. This thinner material may be less rigid and may be used in the filter that may be placed directly on the front face of a high efficiency baffle and may be held in place with an additional metal support. Alternatively, the frame may be adjacent to the filter as a non-internal frame that provides support for the filter.

The filter may include locating slots disposed on the filter, which may be useful for positioning the filter correctly and evenly on the face of the filter (i.e., aligning the filter). This filter also may use handles on the high efficiency filter as a support and locator. The frame material may be glued, sewn, stapled together, or the like.

According to a further embodiment of the invention, a filter may comprise blended materials (e.g., wool and viscose) as well as multiple layers of various materials combined in a multi-laminated structure. For example, a filter may be manufactured to comprise a layer comprising 10 mm square fiberglass mesh as a reinforcing layer or support, a layer comprising 100% viscose, which may serve as a flame barrier, and a layer comprising 100% wool, which may maximize oil absorption. The viscose layer and wool layer may alternatively include additional materials, such as a blend of materials, or the like. In another example, a filter may be manufactured to comprise a layer of aluminum mesh, a layer of viscose, wool, and/or polypropylene staple fiber, and another layer of aluminum mesh. These examples and similar variants may all be manufactured on a continuous line, reducing production costs. Further, such multi-layered filters may be mounted onto the front face of a UL 1046 filter.

A retaining member may be configured to engage the filter media and the supporting layer to hold the filter media and supporting layer together. For example, the retaining member may be configured to clamp the filter media in place and the clamping may occur along a perimeter portion of the filter media. The supporting layer may be next to the filter media or there may be intervening layers or materials. The retaining member may be configured to engage with an opening in the filter media or may contact a perimeter portion of the filter media. The filter media has a length and a width and the retaining member may be configured to extend along the width direction of the filter media and/or the length direction of the filter media. A handle may be connected to or integral with the retaining member.

FIG. 1 depicts a top view of a filter assembly 100, according to an embodiment of the invention. The filter assembly may include a filter material 110, an internal mesh 120, and a filter retainer 130. A notch 140 may be formed in the filter and disposed at each of opposite ends of filter assembly 100. In addition filter assembly 100 may include a handle 150 at each of opposite ends of filter assembly 100, corresponding to each notch 140. A portion of handle 150 may be disposed to cross through notch 140. FIG. 2 depicts a perspective view of filter assembly 100. Filter retainer 130 may latch onto or into a cutout 160 on the side of filter assembly 100.

FIG. 3 depicts a side view of filter assembly 100 and FIG. 4 depicts a front side view of filter assembly 100. Filter assembly 100 may include filter material 110 and an internal mesh 120 sandwiched between two or more layers of filter material 110. As depicted in FIG. 4, handle 150 may be T-shaped, or may take any alternative shape.

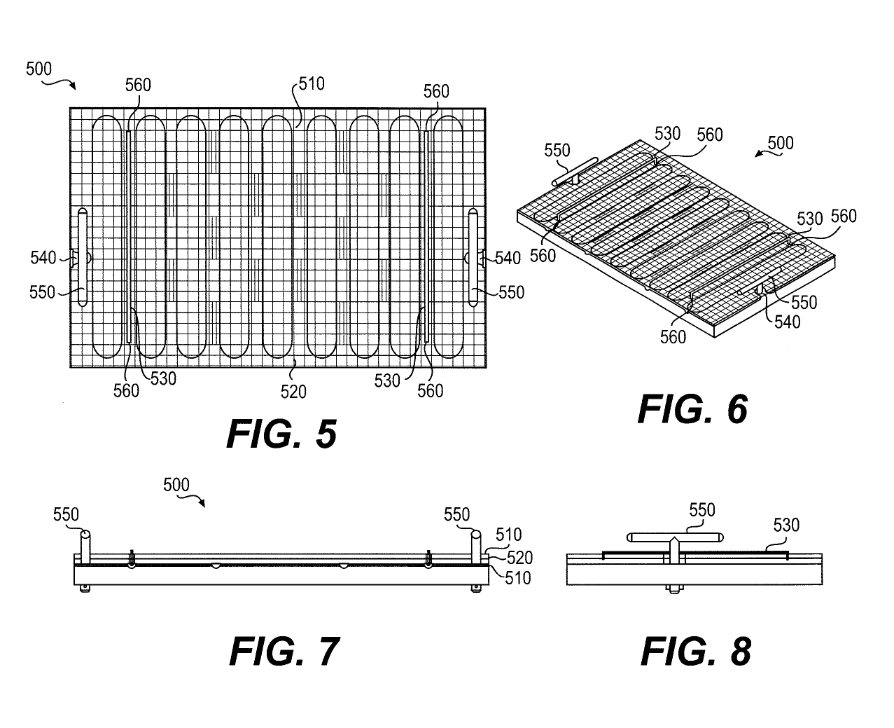

FIG. 5 depicts a top view of a filter assembly 500, according to a further embodiment of the invention. Similar to filter assembly 100, filter assembly 500 may include a filter material 510, an internal mesh 520, and a filter retainer 530. A notch 540 may be formed in the filter and disposed at each of opposite ends of filter assembly 500. In addition filter assembly 500 may include a handle 550 at each of opposite ends of filter assembly 500, corresponding to each notch 540. A portion of handle 550 may be disposed to cross through notch 540. In filter assembly 500, a plurality of punched holes 560 may be formed in the filter assembly and filter retainers 530 may be configured to engage with punched holes 560.

FIG. 6 depicts a perspective view of filter assembly 500, with retaining clips 530 engaged with punched holes 560. FIG. 7 depicts a side view of filter assembly 500 and FIG. 8 depicts a front side view of filter assembly 500. Filter assembly 500 may include filter material 510 and an internal mesh 520 sandwiched between two or more layers of filter material 510. As depicted in FIG. 8, handle 150 may be T-shaped, or may take any alternative shape.

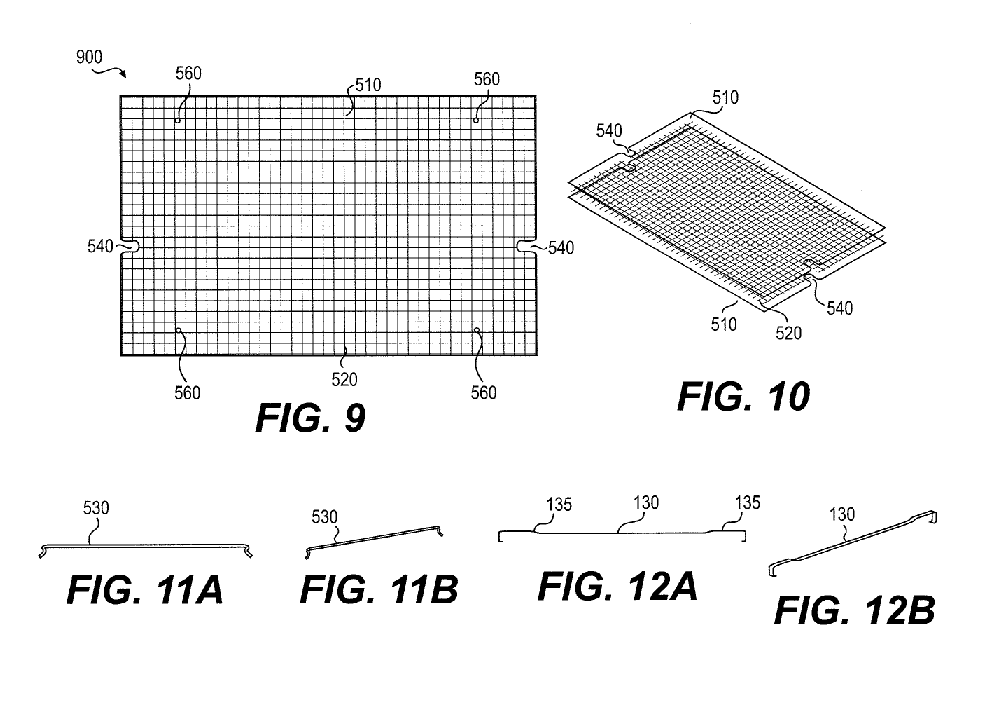

FIG. 9 depicts a top view of a filter 900, which includes filter material 510 and an internal mesh 520. A notch 540 may be formed in filter 900 and disposed at each of opposite ends of filter 900. A plurality of punched holes 560 may be formed in the filter, through which a retaining clip may engage.

FIG. 10 depicts an exploded view of filter 900. An internal mesh 520 may be sandwich between two or more layers of filter material 510. For example, internal mesh 520 may be needled between an upper and lower layer of filter material 510. Internal mesh 520 may comprise fiberglass and/or alternative suitable materials. Alternatively, internal mesh 520 may be replaced by a thin support of, for example, fiber board, metal, resin, or the like.

FIG. 11A depicts a side view of filter retainer 530 and FIG. 11B depicts a perspective view of filter retainer 530. Filter retainer 530 may include a longitudinally extending central portion and a clip portion disposed at each end of the longitudinally extending central portion. The clip portion may comprise, for example, two bent portions that are bent with respect to the longitudinal direction of the central portion. The first bent portion may be bent to form a first angle with respect to the longitudinal direction of the central portion and the second bent portion may be bent to form a second angle that is different than the first angle with respect to the longitudinal direction of the central portion. For example, the second bent portion may be configured to extend outward in the longitudinal direction at an angle to the longitudinal direction of the central portion., as depicted in FIGS. 11A and 11B. Accordingly, filter retainer 530 may be configured to engage with punched holes 560 to hold the filter in place.

FIG. 12A depicts a side view of filter retainer 130 and FIG. 12B depicts a perspective view of filter retainer 130. Filter retainer 130 may include a longitudinally extending central portion and a clip portion disposed at each end of the longitudinally extending central portion. The longitudinally extending central portion may include, for example, two bent or angled portions 135 disposed along the longitudinally extending central portion. Alternatively, the longitudinally extending central portion may be substantially flat. The clip portion may comprise, for example, two bent portions that are bent with respect to the longitudinal direction of the central portion. The first bent portion may be bent to form a first angle with respect to the longitudinal direction of the central portion and the second bent portion may be bent to form a second angle that is different than the first angle with respect to the longitudinal direction of the central portion. For example, the second bent portion may be configured to extend inward in the longitudinal direction and the first bent portion may be configured to extend substantially downward from the longitudinally extending central portion, as depicted in FIGS. 12A and 12B. Accordingly, filter retainer 130 may be configured to engage with cutouts 160 to hold the filter in place.

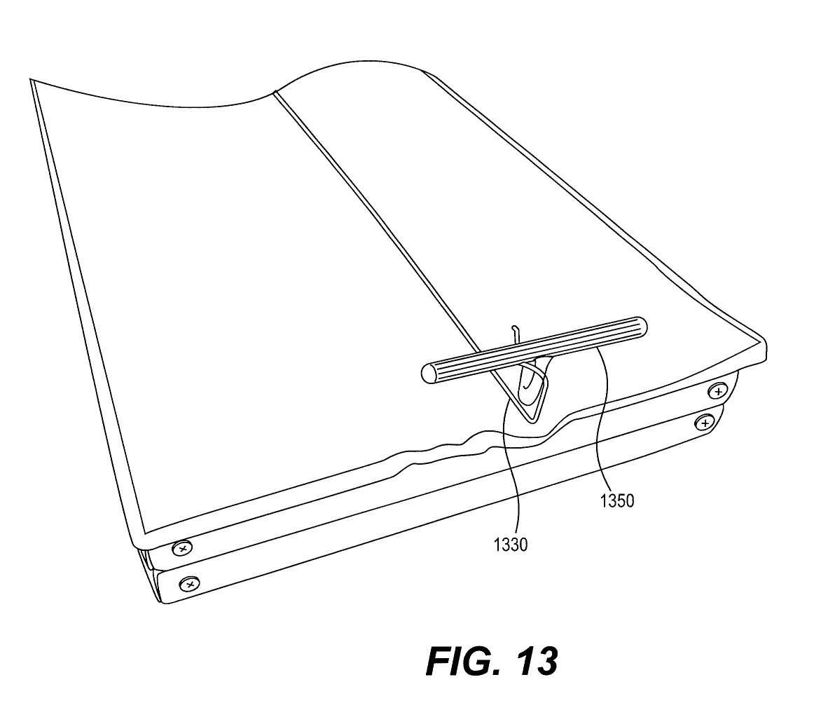

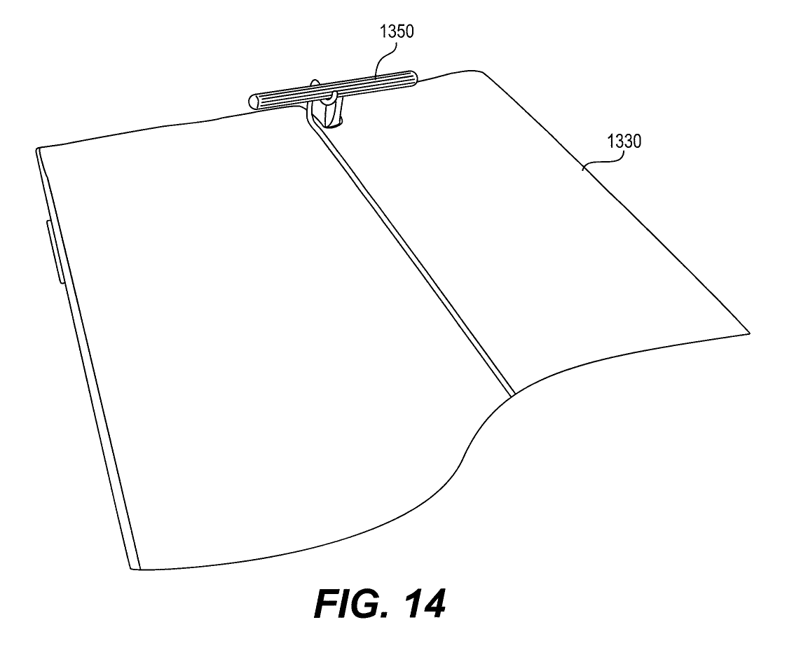

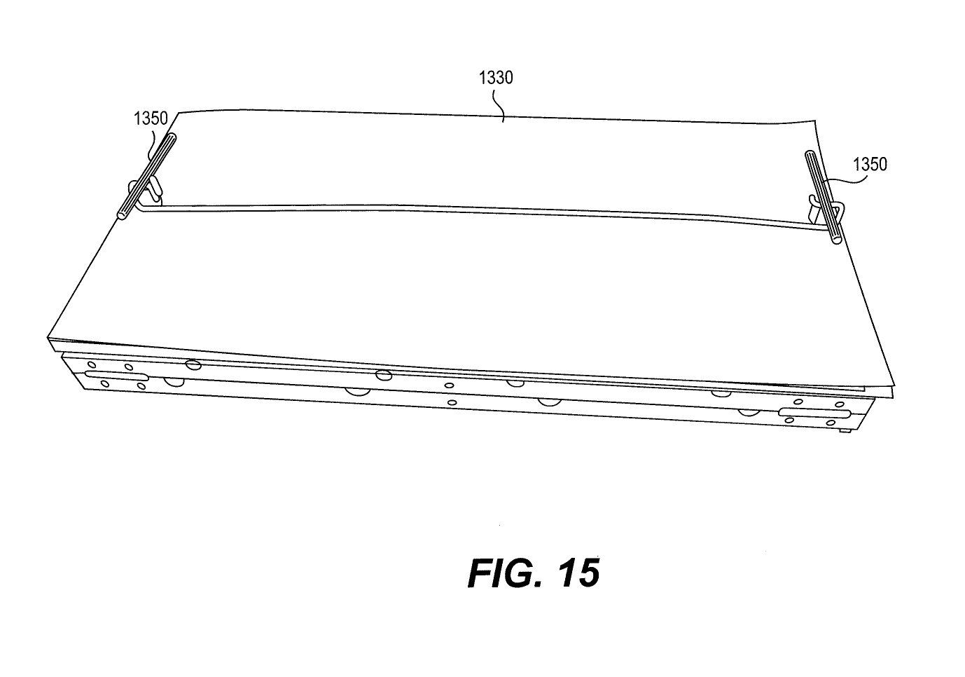

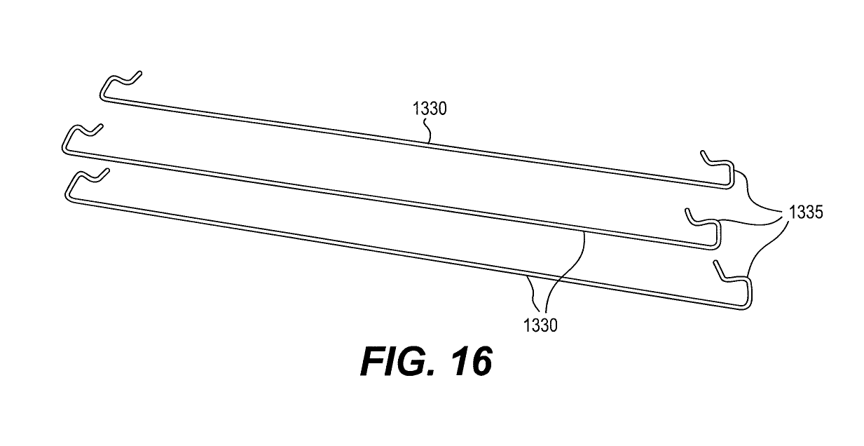

FIG. 13 depicts a perspective partial view of a filter assembly with an alternative filter retainer 1330 and FIG. 14 depicts a perspective partial view of a filter assembly with alternative filter retainer 1330. In addition, FIG. 15 depicts a perspective view of a filter assembly with alternative filter retainer 1330. Moreover, FIG. 16 depicts a side view of alternative filter retainer 1330. As depicted in FIGS. 13-16, filter retainer 1330 may be disposed on top of the filter assembly to engage with handles 1350. Filter retainer 1330 may include a longitudinally extending central portion and a clip portion disposed at each end of the longitudinally extending central portion. The clip portion may comprise, for example, three bent portions that are bent with respect to the longitudinal direction of the central portion. The first bent portion may be bent to form a first angle with respect to the longitudinal direction of the central portion, the second bent portion may be bent to form a second angle that is different than the first angle with respect to the longitudinal direction of the central portion, and the third bent portion may be bent to form a third angle that is different than the first angle and second angle with respect to the longitudinal direction of the central portion. For example, the first bent portion may be configured to extend substantially upward from the longitudinally extending central portion, the second bent portion may be configured to extend inward in the longitudinal direction, and the third bent portion may be configured to extend further inward in the longitudinal direction and further upward from the longitudinally extending central portion, as depicted in FIGS. 13-16. Accordingly, filter retainer 1330 may be configured to engage with handle 1350 to hold the filter in place.

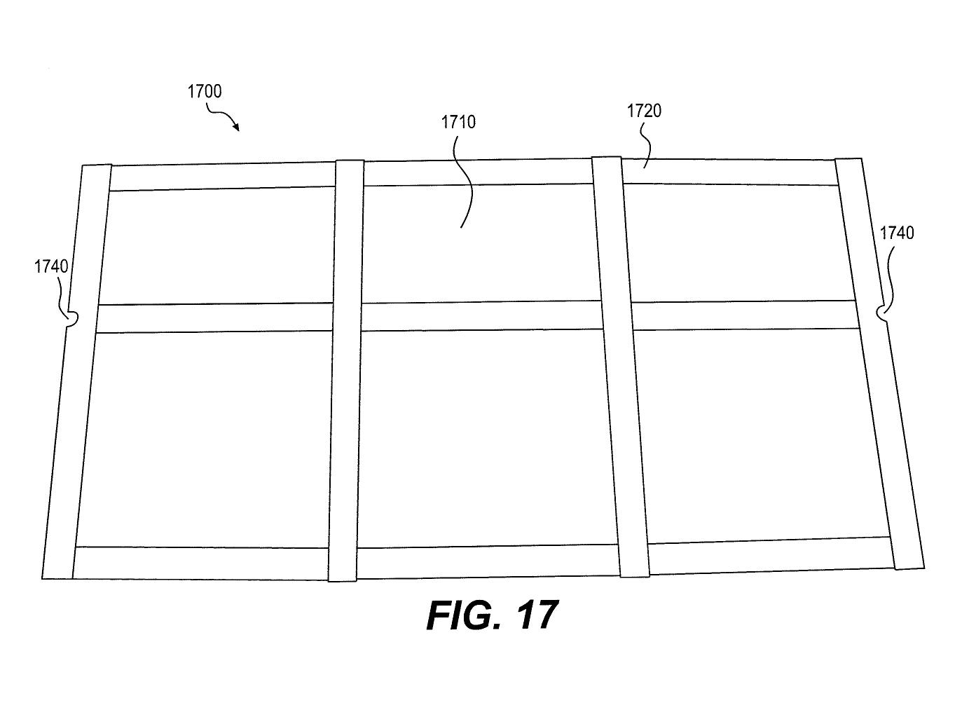

FIG. 17 depicts a perspective view of a filter 1700 with a filter frame 1720. Filter frame 1720 may form a grid to support filter material 1710. A notch 1740 may be formed in frame 1720 at each of opposite ends of frame 1720, as depicted in FIG. 17. Frame 1720 may be used, for example, as an alternative to internal mesh to support filter material 1710.

While the invention has been described in connection with several embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. The specification and the described examples are considered as exemplary only.

What is claimed is:

1. A multi-layered filter assembly comprising:
a filter media comprising at least one of wool, viscose, and thermoplastic polymer material;
a supporting layer proximate to the filter media comprising at least one of a mesh, a frame, and a thin board;
a retaining member configured to engage the filter media and the supporting layer to hold the filter media and supporting layer together.

2. The filter assembly of claim 1, wherein the supporting layer is sandwiched between two or more layers of the filter media.

3. The filter assembly of claim 1, wherein the filter media comprises multiple layers of blended fibers with one or more of the layers treated with a fire resistant additive.

4. The filter assembly of claim 1, wherein the mesh comprises at least one of fiberglass, viscose, cotton, mineral fiber, and metal.

5. The filter assembly of claim 1, wherein the mesh is fire resistant.

6. The filter assembly of claim 1, wherein the retaining member is configured to engage with an opening in the filter media.

7. The filter assembly of claim 6, wherein the filter media comprises a length and a width and the retaining member extends along the width direction.

8. The filter assembly of claim 1, wherein the retaining member is configured to engage with a handle at each of opposite ends of the filter assembly such that a retaining force is applied to the filter media.

9. The filter assembly of claim 8, wherein the filter media comprises a length and a width and the retaining member extends along the length direction.

10. The filter assembly of claim 9, wherein an opening is formed in each of opposite ends in the length direction of the filter media, each opening configured to accommodate a portion of each handle, respectively.

11. The filter assembly of claim 1, wherein the thin board comprises at least one of fiberboard, metal, and resin.

12. The filter assembly of claim 1, wherein the retaining member comprises a central portion and a clip portion at each of opposite ends of the central portion.

13. The filter assembly of claim 12, wherein the clip portion comprises a portion that extends from the central portion to form an angle with the central portion.

14. A method of manufacturing a multi-layered filter assembly comprising:
carding fibers into a web to form a filter media comprising at least one of wool, viscose, and thermoplastic polymer material;
coupling the filter media with a supporting layer comprising at least one of a mesh, a frame, and a thin board,
wherein the coupling comprises at least one of gluing, sewing, or needling in a needle loom; and
trimming or punching the coupled filter media and supporting layer to a predetermined size.

15. The method of manufacturing of claim 14, further comprising:
treating at least one of the filter media and the supporting layer with a fire resistant additive.

16. The method of manufacturing of claim 15, wherein the treating comprises at least one of a chemical bath and a spray application.

17. The method of manufacturing of claim 14, wherein the coupling comprises placing the supporting layer between two or more layers of the filter media.

18. The method of manufacturing of claim 14, wherein the filter media comprises multiple layers of blended fibers with one or more of the layers treated with a fire resistant additive.

19. The method of manufacturing of claim 14, wherein the mesh comprises at least one of fiberglass, viscose, cotton, mineral fiber, and metal.

20. The method of manufacturing of claim 14, wherein the thin board comprises at least one of fiberboard, metal, and resin.
